(19) United States
(12) Patent Application Publication
(10) Pub. No.: US 2019/0224781 A1
(43) Pub. Date: Jul. 25, 2019

(54) LASER WELDING OF OVERLAPPING METAL WORKPIECES ASSISTED BY OSCILLATING LASER BEAM FOCAL POSITION

(71) Applicant: GM GLOBAL TECHNOLOGY OPERATIONS LLC, Detroit, MI (US)

(72) Inventors: David Yang, Shanghai (CN); Wu Tao, Tianmen (CN)

(21) Appl. No.: 16/336,333

(22) PCT Filed: Oct. 20, 2016
(86) PCT No.: PCT/CN2016/102669

§ 371 Date: Mar. 25, 2019

(51) Int. Cl. B23K 26/244; B23K 26/04; B23K 26/082; B23K 26/08; B23K 26/322; B23K 26/073

(52) U.S. Cl. CPC B23K 26/244; B23K 26/048; B23K 26/082; B23K 2101/34; B23K 26/322; B23K 26/073; B23K 26/0884

(57) ABSTRACT

A method of laser welding a workpiece stack-up (10, 10′) that includes at least two overlapping metal workpieces (12, 150, 14) comprises advancing a beam spot (44) of a laser beam (24) relative to a top surface (20) of the workpiece stack-up (10, 10′) and along a beam travel pattern (66) to form a laser weld joint (64) that fusion welds the metal workpieces (12, 150, 14) together. While the beam spot (44) is being advanced between a first point (76) and a second point (78) of one or more weld paths (74) of the beam travel pattern (66), the position of a focal point (52) of the laser beam (24) is oscillated relative to the top surface (20) of the workpiece N stack-up (10, 10′) along a dimension (68) oriented transverse to the top surface (20).

### TECHNICAL FIELD

The technical field of this disclosure relates generally to laser welding and, more particularly, to a method of laser welding together two or more overlapping metal workpieces in which all of the overlapping metal workpieces in the stack-up are steel workpieces, aluminum workpieces, or magnesium workpieces.

### BACKGROUND

Laser welding is a metal joining process in which a laser beam is directed at a metal workpiece stack-up to provide a concentrated energy source capable of effectuating a weld joint between the overlapping constituent metal workpieces. In general, two or more metal workpieces are first aligned and stacked relative to one another such that their faying surfaces overlap and confront to establish a faying interface (or faying interfaces) that extends through an intended weld site. A laser beam is then directed towards and impinges a top surface of the workpiece stack-up. The heat generated from the absorption of energy from the laser beam initiates melting of the metal workpieces down through the metal workpiece impinged by the laser beam and into the underlying metal workpiece(s) to a depth that intersects each of the established faying interfaces. And, if the power density of the laser beam is high enough, a keyhole is produced within the workpiece stack-up. A keyhole is a column of vaporized metal, which may include plasma, derived from the metal workpieces. The keyhole is surrounded by molten workpiece metal and is an effective absorber of energy from the laser beam, thus allowing for deep and narrow penetration of molten workpiece metal into the stack-up compared to instances in which a keyhole is not present.

The laser beam melts the metal workpieces in the workpiece stack-up in very short order once it impinges the top surface of the stack-up. After the metal workpieces are initially melted, a beam spot of the laser beam may be moved across the top surface of the workpiece stack-up along a predefined path. As the beam spot of the laser beam is advanced along the top surface of the stack-up, molten workpiece metal flows around and behind the advancing beam spot. This penetrating molten workpiece metal quickly cools and solidifies into resolidified composite metal workpiece material. Eventually, the transmission of the laser beam at the top surface of the workpiece stack-up is ceased, at which time the keyhole collapses and any molten workpiece metal still remaining within the stack-up solidifies. The collective resolidified composite metal workpiece material obtained by directing the laser beam at the top surface of the stack-up and advancing the beam spot of the laser beam along a weld path constitutes a laser weld joint and serves to autogenously fusion weld the overlapping metal workpieces together.

The automotive industry is interested in using laser welding to manufacture parts that can be installed on a vehicle. In one example, a vehicle door body may be fabricated from an inner door panel and an outer door panel that are joined together by a plurality of laser weld joints. The inner and outer door panels are first stacked relative to each other and secured in place by clamps. A laser beam is then sequentially directed at multiple weld sites around the stacked panels in accordance with a programmed sequence to form the plurality of laser weld joints. The process of laser welding inner and outer door panels—as well as other vehicle component parts such as those used to fabricate hoods, deck lids, body structures such as body sides and cross-members, load-bearing structural members, engine compartments, etc.—is typically an automated process that can be carried out quickly and efficiently. The aforementioned desire to laser weld metal workpieces together is not unique to the automotive industry; indeed, it extends to other industries that may utilize laser welding including the aviation, maritime, railway, and building construction industries, among others.

The use of laser welding to join together coated metal workpieces that are often used in manufacturing practices can present challenges. For example, steel workpieces often include a zinc-based surface coating (e.g., zinc or a zinc-iron alloy) for corrosion protection. Zinc has a boiling point of about 906° C., while the melting point of the underlying steel substrate it coats is typically greater than 1300° C. Thus, when a steel workpiece that includes a zinc-based surface coating is laser welded, high-pressure zinc vapors are readily produced at the surfaces of the steel workpiece and have a tendency to disrupt the laser welding process. In particular, the zinc vapors produced at the faying interface(s) of the steel workpieces can diffuse into the molten steel created by the laser beam unless an alternative escape outlet is provided through the workpiece stack-up. When an adequate escape outlet is not provided, zinc vapors may remain trapped in the molten steel as it cools and solidifies, which may lead to defects in the resulting laser weld joint—such as porosity—as well as other weld joint discrepancies including blowholes, spatter, and undercut joints. These weld joint deficiencies, if sever enough, can unsatisfactorily degrade the mechanical properties of the laser weld joint.

Steel workpieces that are used in manufacturing practices may also include other types of surface coatings for performance-related reasons in lieu of zinc-based coatings. Other notable surface coatings include aluminum-based coatings such as aluminum, an aluminum-silicon alloy, an aluminum-zinc alloy, or an aluminum-magnesium alloy, to name but a few examples. Unlike zinc-based surface coatings, aluminum-based surface coatings do not boil at a temperature below the melting point of steel, so they are unlikely to produce high-pressure vapors at the faying interface(s) of the workpiece stack-up. Notwithstanding this fact, these surface coatings can be melted, especially if a keyhole is present, and, when in a molten state, can combine with the molten steel derived from the bulk of the steel workpieces. The introduction of such disparate molten materials into the molten steel can lead to a variety of weld defects that have the potential to degrade the mechanical properties of the laser weld joint. Molten aluminum or aluminum alloys (e.g., AlSi, AlZn, or AlMg alloys), for instance, can diminish the purity of the molten steel and form brittle Fe—Al intermetallic phases within the weld joint as well as negatively affect the cooling behavior of the molten steel.

Aluminum workpieces are another intriguing candidate for many automobile component parts and structures due to their high strength-to-weight ratios and their ability to improve the fuel economy of the vehicle. Aluminum workpieces, however, almost always include a surface coating that covers an underlying bulk aluminum substrate. This coating may be a native refractory oxide coating that forms passively when fresh aluminum is exposed to atmospheric air or some other oxygen-containing medium. In other instances, the surface coating may be a metallic coating comprised of zinc or tin, or it may be a metal oxide conversion coating comprised of oxides of titanium, zirconium, chromium, or silicon, as disclosed in U.S. Patent Application No. US2014/0360986, the entire contents of which are incorporated herein by reference. The surface coating inhibits corrosion of the underlying aluminum substrate through any of a variety of mechanisms depending on the composition of the coating and may provide other favorable enhancements as well.

One of the main challenges involved in laser welding aluminum workpieces is the relatively high solubility of hydrogen in molten aluminum. Upon solidification of the molten aluminum, dissolved hydrogen becomes trapped, leading to porosity within the laser weld joint. In addition to the challenges posed by hydrogen solubility, the surface coating commonly included in the aluminum workpieces is believed to contribute to the formation of weld defects in the laser weld joint. When, for example, the surface coating of one or more of the aluminum workpieces is a refractory oxide coating, residual oxides can contaminate the molten aluminum created by the laser beam due to the high melting point and mechanical toughness of the coating. In another example, if the surface coating is zinc, the coating may readily vaporize to produce high-pressure zinc vapors that may diffuse into and through the molten aluminum, thus leasing to porosity within the weld joint and other weld deficiencies unless provisions are made to vent the zinc vapors away from the weld site. A variety of other challenges may also complicate the laser welding process in a way that adversely affects the mechanical properties of the laser weld joint.

Magnesium workpieces are yet another intriguing candidate for many automobile component parts and structures due to their high strength-to-weight ratios—even more so that aluminum workpieces—and their ability to improve the fuel economy of the vehicle. Like aluminum workpieces, magnesium workpieces almost always include a surface coating that covers an underlying bulk magnesium substrate. This coating may be a native refractory oxide coating that forms passively when fresh magnesium is exposed to atmospheric air or some other oxygen-containing medium. In other instances, the surface coating may be a metallic conversion coating comprised of metal oxides, metal phosphates, or metal chromates. The surface coating included in the magnesium workpiece can help protect the underlying magnesium substrate against protection through any of a number of mechanisms and may also contribute to other favorable properties as well.

The laser welding of magnesium workpieces has historically been more challenging when compared to steel and aluminum workpieces. The major challenge involved in laser welding magnesium workpieces is porosity in the laser weld joint. Such porosity may be derived from entrapped gas in the micropores of the bulk magnesium substrates of the magnesium workpieces, which can undergo expansion and coalescence in the molten magnesium, especially when the magnesium workpieces include a die cast magnesium alloy substrate. Weld joint porosity can also be derived from other factors including the rejection of dissolved hydrogen during solidification of the molten magnesium created by the laser beam. Still further, when the surface coating of the magnesium workpiece(s) is a refractory oxide coating, the magnesium hydroxide component (due to exposure to humidity) of the surface coating can evolve water vapor when heated by the laser beam. The evolved water vapor may diffuse into and through the molten magnesium and contribute to entrained porosity within the laser weld joint. A host of other challenges may also may also disturb the laser welding process and contribute to the formation of a laser weld joint with degraded mechanical properties.

### SUMMARY OF THE DISCLOSURE

A method of laser welding a workpiece stack-up that includes overlapping metal workpieces is disclosed. The workpiece stack-up includes two or more metal workpieces, with all of the metal workpieces in the stack-up being steel workpieces, aluminum workpieces, or magnesium workpieces. In other words, the workpiece stack-up includes two or more overlapping steel workpieces, two or more overlapping aluminum workpieces, or two or more overlapping magnesium workpieces. The various metal workpieces included in each of the aforementioned workpiece stack-ups presents challenges when trying to join the workpieces together with a laser beam during assorted implementations of laser welding including remote laser welding and conventional laser welding. The disclosed laser welding method seeks to counter those challenges by cyclically varying the focal position laser beam during formation of a laser weld joint while preferably maintaining the laser beam at a constant power level and travel speed. The effectiveness of repeatedly varying the focal position enables the disclosed laser welding method to be performed without requiring—but of course not prohibiting—the conventional industry practice of intentionally imposing gaps between the metal workpieces at the faying interface(s), typically by laser scoring or mechanical dimpling, as a mechanism to try and alleviate the diffusion of vapors into the molten workpiece metal.

The disclosed laser welding method involves providing a workpiece stack-up that includes two or more overlapping metal workpieces (e.g., two or more overlapping steel, aluminum, or magnesium workpieces). The metal workpieces are fitted and stacked together such that a faying interface is formed between the faying surfaces of each pair of adjacent overlapping metal workpieces at a weld site. For example, in one embodiment, the workpiece stack-up includes first and second metal workpieces having first and second faying surfaces, respectively, that overlap and confront one another to establish a single faying interface. In another embodiment, the workpiece stack-up includes an additional third metal workpiece situated between the first and second metal workpieces. In this way, the first and second metal workpieces have first and second faying surfaces, respectively, that overlap and confront opposed faying surfaces of the third metal workpiece to establish two faying interfaces. When a third metal workpiece is present, the first and second metal workpieces may be separate and distinct parts or, alternatively, they may be different portions of the same part, such as when an edge of one part is folded over a free edge of another part.

After the workpiece stack-up is assembled and provided, a laser beam is directed at a top surface of the workpiece stack-up. The laser beam impinges the top surface at a beam spot. The term “beam spot,” as used herein, broadly refers to the sectional surface area of the laser beam as projected onto a plane oriented along the top surface of the workpiece stack-up. The focused energy of the laser beam is absorbed by the metal workpieces to create a molten metal weld pool that penetrates into the workpiece stack-up from the top surface towards the bottom surface while intersecting each faying interface established within the stack-up. The power density of the delivered laser beam is selected to carry out the practice of laser welding in either conduction welding mode or keyhole welding mode. In conduction welding mode, the power density of the laser beam is relatively low, and the energy of the laser beam is conducted as heat through the metal workpieces to create only the molten metal weld pool. In keyhole welding mode, the power density of the laser beam is high enough to vaporize the metal workpieces beneath the beam spot of the laser beam to produce a keyhole that is surrounded by the molten metal weld pool. The keyhole provides a conduit for efficient energy absorption deeper into workpiece stack-up which, in turn, facilitates deeper and narrower penetration of the molten metal weld pool. The molten metal weld pool and the keyhole, if formed, may fully or partially penetrate the workpiece stack-up.

The beam spot of the laser beam is advanced relative to the top surface of the workpiece stack-up along a beam travel pattern following creation of the molten metal weld pool and, optionally, the keyhole. Advancing the beam spot of the laser beam along the beam travel pattern translates the keyhole and the molten metal weld pool along a route that corresponds to the patterned movement of the beam spot relative to the top surface of the workpiece stack-up. Moreover, the advancement of the beam spot along the beam travel pattern causes the molten metal weld pool to flow around and behind the beam spot—particularly if a keyhole is present—and to elongate in the wake of the advancing beam spot. Depending on the geometry of the beam travel pattern, the molten metal weld pool may solidify into a defined trail behind the forward advancement of the beam spot, or it may merge and grow into a larger melt puddle that solidifies into a consolidated nugget. Regardless of its final shape and structure, the resolidified composite metal workpiece material obtained from translating the molten metal weld pool through the workpiece stack-up is comprised of material from each of the metal workpiece penetrated by the weld pool. The collective resolidified composite metal workpiece material constitutes the laser weld joint that autogenously fusion welds the workpieces together.

During some or all of the time that the laser beam (and thus its beam spot) is being advanced along the beam travel pattern, the position of the focal point of the laser beam relative to the top surface of the workpiece stack-up is oscillated along a dimension oriented transverse to the top surface. The transverse dimension along which the position of the focal point is oscillated is parallel to a longitudinal axis of the laser beam and, accordingly, may oriented normal to a plane of the top surface or inclined as is the case when the laser beam has an angle of incidence of up to 60°. Oscillating the focal point position of the laser beam involves cyclically varying the distance between the focal point and the top surface of the workpiece stack-up which, here, is referred to as the “focal distance” and is measured along the longitudinal axis of the laser beam. More specifically, in a preferred embodiment, the focal point oscillation is linear or undulating and is bound between constant minimum focal positions (farthest from the transmitting source of the laser beam) and constant maximum focal positions (closest to the transmitting source of the laser beam). The focal point oscillation may be periodic or nonperiodic as a function of time. A periodic oscillation is one that exhibits consistent variances in focal distance over regular time intervals, and a nonperiodic oscillation is one that is not considered to be periodic. The focal point oscillation may be carried out slowly or rapidly, but, in many instances, is performed at a frequency between 10 Hz and 6000 Hz.

The focal point oscillations are believed to have a positive impact on the strength and other mechanical properties of the obtained laser weld joint. Such results can be realized since oscillating the focal point effectively changes the power density and heat input of the laser beam over time, especially if the power level and travel speed of the laser beam are kept constant, which can help restrain the temperature of the molten metal weld pool, thereby allowing the weld pool to be kept at lower temperature than would otherwise be the case in the absence of focal point oscillations. The ability to regulate and maintain a lower temperature in the molten metal weld pool supports better strength and properties in the obtained laser weld joint by reducing the solubility of certain gaseous substances (e.g., zinc, hydrogen, etc.) in the weld pool. And, when lower quantities of dissolved gasses are dissolved in the molten metal weld pool, there is less of a tendency for porosity to form within the laser weld joint as the weld pool solidifies. Additionally, oscillating the position of the focal point can agitate the molten metal weld pool and can even grow and shrink the weld pool when the focal point oscillations are undulating in nature. Such induced agitation of the molten metal weld pool helps promote the release of gases trapped within the molten material of the weld pool and thereby deceases the proclivity for porosity formation in the obtained laser weld joint. Other weld joint deficiencies—such as spatter, blowholes, and undercut joints—may also be minimized.

In a preferred embodiment, a remote laser welding apparatus is used to form the laser weld joint in the workpiece stack-up. The remote laser welding apparatus includes a scanning optic laser head that houses indexible optical components that can move the beam spot of the laser beam relative to and along the top surface of the workpiece stack-up in a wide variety of simple and complex beam travel patterns while simultaneously oscillating the position of the focal point of the laser beam as desired. Although remote laser welding is a preferred approach for coordinating the programmed beam travel pattern and focal point position oscillations called for in the disclosed laser welding method, other forms of laser welding may also be employed. For example, the disclosed laser welding method may also be carried out by a conventional laser welding apparatus that relies on precision robotic movement of its laser head to effectuate movement of the laser beam relative to and along the top surface as well as the position of the focal point. Still further, other laser welding apparatuses not specifically mentioned here may be used so long as they can support tracing of the designated beam travel pattern and the accompanying focal point oscillations.

### BRIEF DESCRIPTION OF THE DRAWINGS

FIG. 1 is a perspective view of an embodiment of a remote laser welding apparatus for forming a laser weld joint within a workpiece stack-up that includes two or more metal workpieces, wherein the laser weld joint fusion welds the two or more metal workpieces together;

FIG. 1A is a magnified view of the laser beam depicted in FIG. 1 showing a focal point and a longitudinal axis of general laser beam;

FIG. 2 is a cross-sectional side view of the workpiece stack-up depicted in FIG. 1 along with a molten metal weld pool and a keyhole produced by a laser beam, wherein both the molten metal weld pool and the keyhole fully penetrate the workpiece stack-up during laser welding, and further showing the focal point of the laser beam positioned at a maximum focal position of a focal point component run;

FIG. 3 is a cross-sectional side view of the workpiece stack-up depicted in FIG. 1 along with a molten metal weld pool and a keyhole produced by a laser beam, wherein both the molten metal weld pool and the keyhole fully penetrate the workpiece stack-up during laser welding, and further showing the focal point of the laser beam positioned at a minimum focal position of a focal point component run;

FIG. 4 is a sectional plan view (taken along line 4-4 in FIG. 2) of a beam spot of the laser beam as projected onto a plane oriented along the top surface of the workpiece stack-up;

FIG. 5 is a cross-sectional side view of the workpiece stack-up depicted in FIG. 1 along with a molten metal weld pool and a keyhole produced by a laser beam, wherein both the molten metal weld pool and the keyhole partially penetrate the workpiece stack-up during laser welding, and further showing the focal point of the laser beam positioned at a maximum focal position of a focal point component run;

FIG. 6 is a cross-sectional side view of the workpiece stack-up depicted in FIG. 1 along with a molten metal weld pool and a keyhole produced by a laser beam, wherein both the molten metal weld pool and the keyhole partially penetrate the workpiece stack-up during laser welding, and further showing the focal point of the laser beam positioned at a maximum focal position of a focal point component run;

FIG. 7 is a side elevational view of the laser beam that illustrates the position of the focal point of the laser beam being oscillated in a linear fashion;

FIG. 8 is a side elevational view of the laser beam that illustrates the position of the focal point of the laser beam being oscillated in an undulating fashion;

FIG. 9 is a graphical illustration of the focal position of the laser beam being oscillated along a series of focal point component between constant maximum and minimum focal positions according to one embodiment of the disclosed laser welding method;

FIG. 10 is a plan view of the top surface of a workpiece stack-up during laser welding according to the disclosed method in which the beam spot of the laser beam is being advanced relative to the top surface of the stack-up along a weld path of a generic representative beam travel pattern;

FIG. 11 depicts an embodiment of the beam travel pattern as projected onto the top surface of the workpiece stack-up that may be traced by the beam spot of the laser beam during formation of a laser weld joint between the two or more overlapping metal workpieces included in the workpiece stack-up;

FIG. 12 depicts another embodiment of the beam travel pattern as projected onto the top surface of the workpiece stack-up that may be traced by the beam spot of the laser beam during formation of a laser weld joint between the two or more overlapping metal workpieces included in the workpiece stack-up;

FIG. 13 depicts still another embodiment of the beam travel pattern as projected onto the top surface of the workpiece stack-up that may be traced by the beam spot of the laser beam during formation of a laser weld joint between the two or more overlapping metal workpieces included in the workpiece stack-up;

FIG. 14 depicts yet another embodiment of the beam travel pattern as projected onto the top surface of the workpiece stack-up that may be traced by the beam spot of the laser beam during formation of a laser weld joint between the two or more overlapping metal workpieces included in the workpiece stack-up;

FIG. 15 depicts still another embodiment of the beam travel pattern as projected onto the top surface of the workpiece stack-up that may be traced by the beam spot of the laser beam during formation of a laser weld joint between the two or more overlapping metal workpieces included in the workpiece stack-up;

FIG. 16 is a cross-sectional side view of the workpiece stack-up taken from the same perspective as shown in FIG. 2 with the molten metal weld pool and the keyhole fully penetrating the stack-up, although here the workpiece stack-up includes three overlapping metal workpieces that establish two faying interfaces, as opposed to two overlapping metal workpieces that establish a single faying interface as depicted in FIG. 2; and

FIG. 17 is a cross-sectional side view of the workpiece stack-up taken from the same perspective as shown in FIG. 3 with the molten metal weld pool and the keyhole fully penetrating the stack-up, although here the workpiece stack-up includes three overlapping metal workpieces that establish two faying interfaces, as opposed to two overlapping metal workpieces that establish a single faying interface as depicted in FIG. 3.

### DETAILED DESCRIPTION

The disclosed method of laser welding a workpiece stack-up comprised of two or more overlapping metal workpieces involves forming a laser weld joint by oscillating a position of a focal point of a laser beam relative to a top surface of the stack-up along a dimension oriented transverse to a top surface at least part of the time while advancing the laser beam relative to a plane of the top surface along a beam travel pattern. Any type of laser welding apparatus, including remote and conventional laser welding apparatuses, may be employed to form the laser weld joint while oscillating the focal point of the laser beam and tracing the beam travel pattern. The laser beam may be a solid-state laser beam or a gas laser beam depending on the characteristics and compositions of the metal workpieces being joined and the laser welding apparatus being used. Some notable solid-state lasers that may be used are a fiber laser, a disk laser, a direct diode laser, and a Nd:YAG laser, and a notable gas laser that may be used is a CO₂ laser, although other types of lasers may certainly be used. In a preferred implementation of the disclosed method, which is described below in more detail, a remote laser welding apparatus is operated to form the laser weld joint.

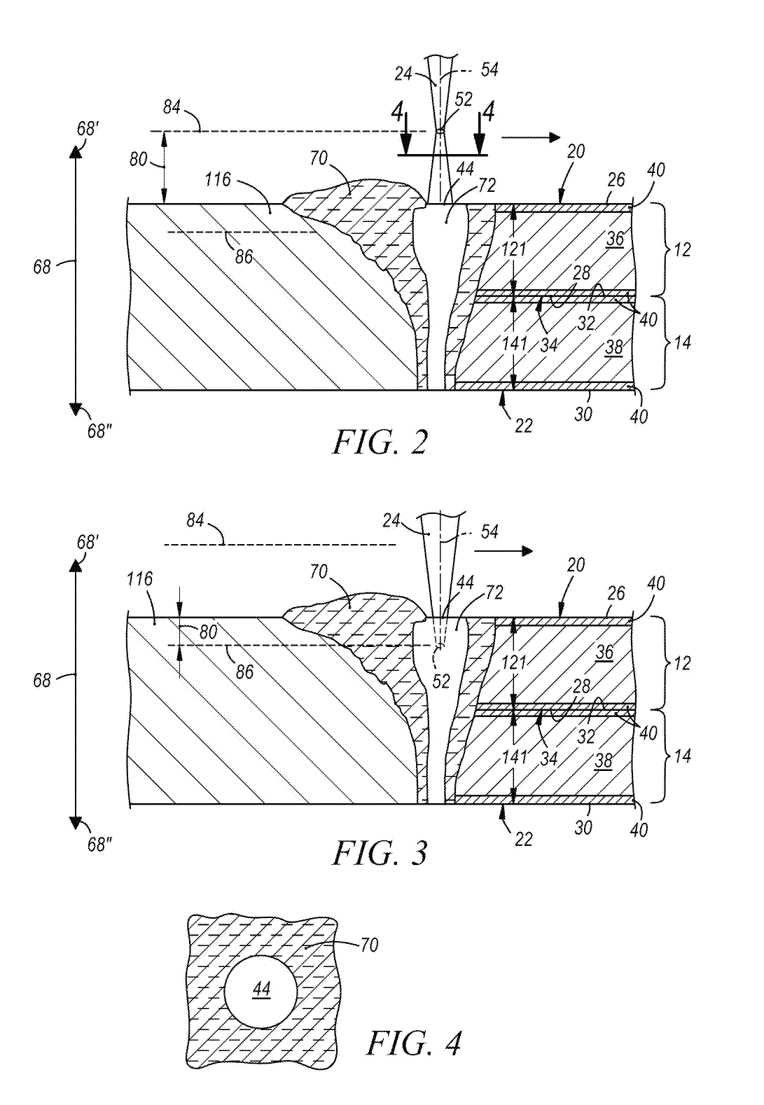

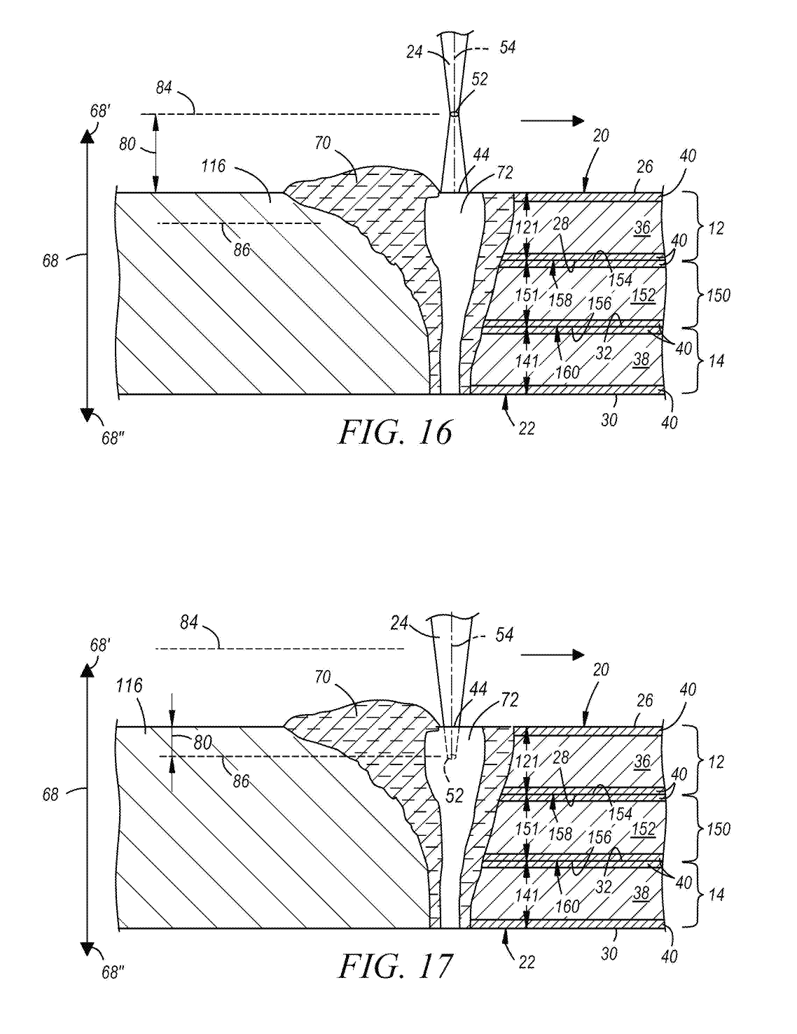

The laser welding method may be performed on a variety of workpiece stack-up configurations. For example, the disclosed method may be used in conjunction with a “2T” workpiece stack-up (FIGS. 2-3 and 5-6) that includes two overlapping and adjacent metal workpieces, or it may be used in conjunction with a “3T” workpiece stack-up (FIGS. 16-17) that includes three overlapping and adjacent metal workpieces. Still further, in some instances, the disclosed method may be used in conjunction with a “4T” workpiece stack-up (not shown) that includes four overlapping and adjacent metal workpieces. The several metal workpieces included in the workpiece stack-up may have similar or dissimilar compositions, provided they are part of the same base metal group (e.g., steel, aluminum, or magnesium), if desired. The laser welding method is carried out in essentially the same way to achieve the same results regardless of whether the workpiece stack-up includes two overlapping metal workpieces or more than two overlapping metal workpieces. Any differences in workpiece stack-up configurations can be easily accommodated by adjusting the laser welding process.

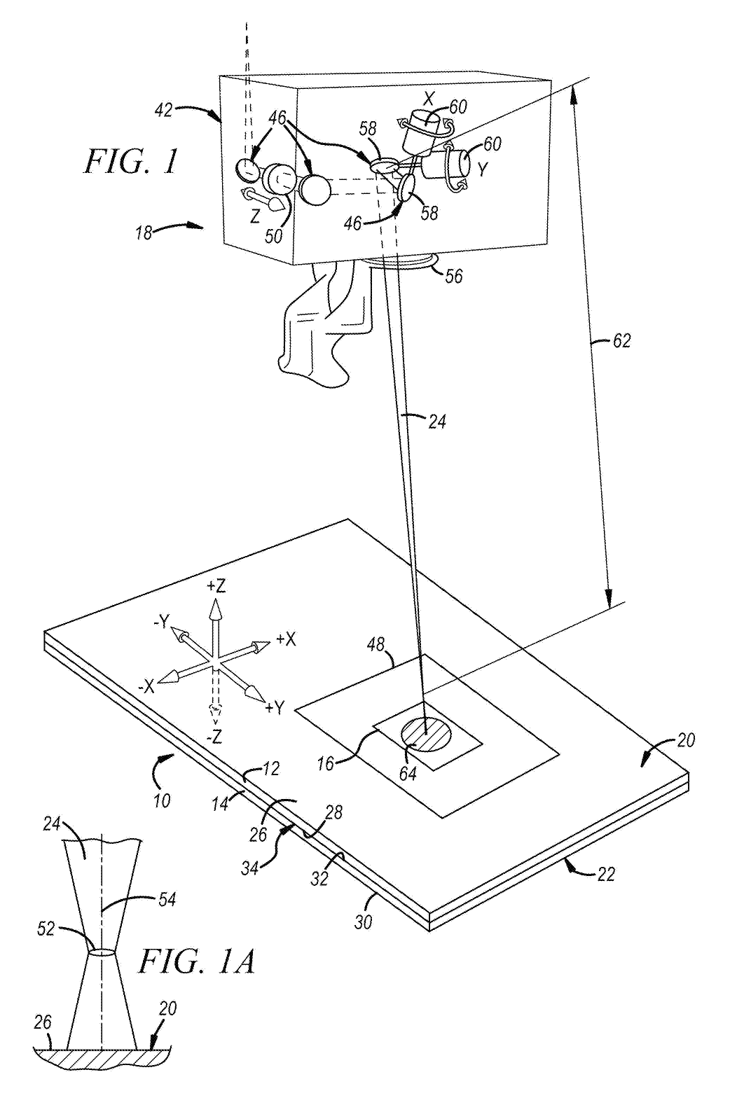

Referring now generally to FIG. 1, a method of laser welding a workpiece stack-up 10 is shown in which the stack-up 10 includes at least a first metal workpiece 12 and a second metal workpiece 14 that overlap at a weld site 16 where the disclosed laser welding method is conducted using a remote laser welding apparatus 18. The first and second metal workpieces 12, 14 provide a top surface 20 and a bottom surface 22, respectively, of the workpiece stack-up 10. The top surface 20 of the workpiece stack-up 10 is made available to the remote laser welding apparatus 18 and is accessible by a laser beam 24 emanating from the remote laser welding apparatus 18. And since only single side access is needed to conduct laser welding, there is no need for the bottom surface 22 of the workpiece stack-up 10 to be made accessible in the same way. The terms “top surface” and “bottom surface” are thus relative designations that identify the surface of the stack-up 10 facing the remote laser welding apparatus 18 (top surface) and the surface of the stack-up 10 facing in the opposite direction. Moreover, while only one weld site 16 is depicted in the Figures for the sake of simplicity, skilled artisans will appreciate that laser welding in accordance with the disclosed laser welding method can be practiced at multiple different weld sites spread throughout the same workpiece stack-up.

The workpiece stack-up 10 may include only the first and second metal workpieces 12, 14, as shown in FIGS. 2-3 and 5-6. Under these circumstances, and as shown best in FIGS. 2-3, the first metal workpiece 12 includes an exterior outer surface 26 and a first faying surface 28, and the second metal workpiece 14 includes an exterior outer surface 30 and a second faying surface 32. The exterior outer surface 26 of the first metal workpiece 12 provides the top surface 20 of the workpiece stack-up 10 and the exterior outer surface 30 of the second metal workpiece 14 provides the oppositely-facing bottom surface 22 of the stack-up 10. And, since the two metal workpieces 12, 14 are the only workpieces present in this embodiment of the workpiece stack-up 10, the first and second faying surfaces 28, 32 of the first and second metal workpieces 12, 14 overlap and confront to establish a faying interface 34 that extends through the weld site 16. In other embodiments of the disclosed laser welding method, one of which is described below in connection with FIGS. 16-17, the workpiece stack-up may include an additional metal workpiece disposed between the first and second metal workpieces 12, 14 to provide the stack-up 10 with three metal workpieces instead of two.

The term “faying interface” is used broadly in the present disclosure and is intended to encompass a wide range of overlapping relationships between the confronting first and second faying surfaces 28, 32 that can accommodate the practice of laser welding. For instance, the faying surfaces 28, 32 may establish the faying interface 34 by being in direct or indirect contact. The faying surfaces 28, 32 are in direct contact with each other when they physically abut and are not separated by a discrete intervening material layer or gaps that fall outside of normal assembly tolerance ranges. The faying surfaces 28, 32 are in indirect contact when they are separated by a discrete intervening material layer such as a structural adhesive—and thus do not experience the type of interfacial abutment that typifies direct contact—yet are in close enough proximity that laser welding can be practiced. As another example, the faying surfaces 28, 32 may establish the faying interface 34 by being separated by gaps that are purposefully imposed. Such gaps may be imposed between the faying surfaces 28, 32 by creating protruding features on one or both of the faying surfaces 28, 32 through laser scoring, mechanical dimpling, or otherwise. The protruding features maintain intermittent contact points between the faying surfaces 28, 32 that keep the faying surfaces 28, 32 spaced apart outside of and around the contact points by up to 1.0 mm and, preferably, between 0.2 mm and 0.8 mm.

Still referring to FIGS. 2-3, the first metal workpiece 12 includes a first base metal substrate 36 and the second metal workpiece 14 includes a second base metal substrate 38. The first and second base metal substrates 36, 38 may be composed of steel, aluminum, or magnesium, with the proviso that each of the base metal substrates 36, 38 are part of the same base metal group; that is, the first and second base metal substrates 36, 38 are both composed of steel, both composed of aluminum, or both composed of magnesium. At least one of the first or second base metal substrates 36, 38 may include a surface coating 40. The surface coating(s) 40 may be employed on one or both of the base metal substrates 36, 38 for various reasons including corrosion protection, strength enhancement, and/or to improve processing, among other reasons, and the composition of the coating(s) 40 is based largely on the composition of the underlying base metal substrates 36, 38. Taking into the account the thickness of the base steel substrates 36, 38 and their optional surface coatings 40, each of a thickness 121 of the first metal workpiece 12 and a thickness 141 of the second metal workpiece 14 preferably ranges from 0.4 mm to 4.0 mm at least at the weld site 16. The thicknesses 121, 141 of the first and second steel workpieces 12, 14 may be the same of different from each other.

Each of the first and second base metal substrates 36, 38 may be coated with a surface coating 40 as shown here in FIGS. 2-3. The surface coatings 40, in turn, provide the metal workpieces 12, 14 with their respective exterior outer surfaces 26, 30 and their respective faying surfaces 28, 32. In another embodiment, only the first base metal substrate 36 includes a surface coating 40 while the second metal substrate 36 is uncoated or bare. Under these circumstances, the surface coating 40 covering the first base metal substrate 36 provides the first metal workpiece 12 with its exterior outer and faying surfaces 26, 28, while the second base metal substrate 38 provides the second metal workpiece 14 with its exterior outer and faying surfaces 30, 32. In yet another embodiment, only the second base metal substrate 38 includes the surface coating 40 while the first base metal substrate 36 is uncoated or bare. Consequently, in this case, the first base metal substrate 36 provides the first metal workpiece 12 with its exterior outer and faying surfaces 26, 28, while the surface coating 40 covering the second base metal substrate 38 provides the second metal workpiece 14 with its exterior outer and faying surfaces 30, 32.

The base metal substrates 36, 38 may assume any of a wide variety of metal forms and compositions that fall within the broadly-recited base metal groups of steel, aluminum, and magnesium. For instance, if composed of steel, each of the base metal substrates 36, 38 (referred to for the moment as the first and second base steel substrates 36, 38) may be separately composed of any of a wide variety of steels including a low carbon (mild) steel, interstitial-free (IF) steel, bake-hardenable steel, high-strength low-alloy (HSLA) steel, dual-phase (DP) steel, complex-phase (CP) steel, martensitic (MART) steel, transformation induced plasticity (TRIP) steel, twining induced plasticity (TWIP) steel, and boron steel such as when the workpiece(s) 12, 14 include press-hardened steel (PHS). Moreover, each of the first and second base steel substrates 36, 38 may have been treated to obtain a particular set of mechanical properties, including being subjected to heat-treatment processes such as annealing, quenching, and/or tempering. The first and second base steel substrates 36, 38 may be hot or cold rolled to their final thicknesses and may be pre-fabricated to have a particular profile suitable for assembly into the workpiece stack-up 10.

The surface coating 40 present on one or both of the base steel substrates 36, 38 is preferably comprised of a zinc-based material or an aluminum-based material. Some examples of a zinc-based material include zinc or a zinc alloy such as a zinc-nickel alloy or a zinc-iron alloy. One particularly preferred zinc-iron alloy that may be employed has a bulk average composition that includes 8 wt % to 12 wt % iron and 0.5 wt % to 4 wt % aluminum with the balance (in wt %) being zinc. A coating of a zinc-based material may be applied by hot-dip galvanizing (hot-dip galvanized zinc coating), electrogalvanizing (electrogalvanized zinc coating), or galvannealing (galvanneal zinc-iron alloy), typically to a thickness of between 2 μm to 50 μm, although other procedures and thicknesses of the attained coating(s) may be employed. Some examples of a suitable aluminum-based material include aluminum, an aluminum-silicon alloy, an aluminum-zinc alloy, and an aluminum-magnesium alloy. A coating of an aluminum-based material may be applied by dip coating, typically to a thickness of 2 μm to 30 μm, although other coating procedures and thicknesses of the attained coating(s) may be employed. Taking into the account the thicknesses of the base steel substrates 36, 38 and their surface coating(s) 40, if present, the overall thickness of each of the first and second steel workpieces 12, 14 preferably ranges from 0.4 mm to 4.0 mm, or more narrowly from 0.5 mm to 2.0 mm, at least at the weld site 16.

If the first and second base metal substrates 36, 38 are composed of aluminum, each of the base metal substrates 36, 38 (referred to for the moment as the first and second base aluminum substrates 36, 38) may be separately composed of unalloyed aluminum or an aluminum alloy that includes at least 85 wt % aluminum. Some notable aluminum alloys that may constitute the first and/or second base aluminum substrates 36, 38 are an aluminum-magnesium alloy, an aluminum-silicon alloy, an aluminum-magnesium-silicon alloy, or an aluminum-zinc alloy. Additionally, each of the base aluminum substrates 36, 38 may be separately provided in wrought or cast form. For example, each of the base aluminum substrates 36, 38 may be composed of a 4xxx, 5xxx, 6xxx, or 7xxx series wrought aluminum alloy sheet layer, extrusion, forging, or other worked article, or a 4xx.x, 5xx.x, or 7xx.x series aluminum alloy casting. Some more specific kinds of aluminum alloys that can be used as the first and/or second base aluminum substrates 36, 38 include AA5182 and AA5754 aluminum-magnesium alloy, AA6011 and AA6022 aluminum-magnesium-silicon alloy, AA7003 and AA7055 aluminum-zinc alloy, and Al-10Si—Mg aluminum die casting alloy. The first and/or second base aluminum substrates 36, 38 may be employed in a variety of tempers including annealed (O), strain hardened (H), and solution heat treated (T).

The surface coating 40 present on one or both of the base aluminum substrates 36, 38 may be a native refractory oxide coating comprised of aluminum oxide compounds that forms passively when fresh aluminum from the base aluminum substrate 36, 38 is exposed to atmospheric air or some other oxygen-containing medium. The surface coating 40 may also be a metallic coating comprised of zinc or tin, or it may be a metal oxide conversion coating comprised of oxides of titanium, zirconium, chromium, or silicon as disclosed in U.S. Patent Application No. US2014/0360986. A typical thickness of the surface coating 40, if present, lies anywhere from 1 nm to 10 μm depending on the composition of the coating 40 and the manner in which the coating 40 is derived, although other thicknesses may be employed. Passively formed refractory oxide coatings, for example, often have thicknesses that range from 2 nm to 10 nm when the underlying aluminum material is an aluminum alloy. Taking into account the thicknesses of the base aluminum substrates 36, 38 and their surface coating(s) 40, if present, the overall thickness of each of the first and second aluminum workpieces 12, 14 preferably ranges of 0.4 mm to 6.0 mm, or more narrowly from 0.5 mm to 3.0 mm, at least at the weld site 16.

If the first and second base metal substrates 36, 38 are composed of magnesium, each of the base metal substrates 36, 38 (referred to for the moment as the first and second base magnesium substrates 36, 38) may be separately composed of unalloyed magnesium or a magnesium alloy that includes at least 85 wt % magnesium. Some notable magnesium alloys that may constitute the first and/or second base magnesium substrates 36, 38 are a magnesium-zinc alloy, a magnesium-aluminum alloy, a magnesium-aluminum-zinc alloy, a magnesium-aluminum-silicon alloy, and a magnesium-rare earth alloy. Additionally, each of the base magnesium substrates 36, 38 may be separately provided in wrought (sheet, extrusion, forging, or other worked article) or cast form. A few specific examples of magnesium alloys that can be used as the first and/or second base magnesium substrates 36, 38 include, but are not limited to, AZ91D die cast or wrought (extruded or sheet) magnesium alloy, AZ31B die cast or extruded (extruded or sheet) magnesium alloy, and AM60B die cast magnesium alloy. The first and/or second base magnesium substrates 36, 38 may be employed in a variety of tempers including annealed (O), strain hardened (H), and solution heat treated (W).

The surface coating 40 present on one or both of the base magnesium substrates 36, 38 may be a native refractory oxide coating comprised of magnesium oxide compounds (and possibly magnesium hydroxide compounds) that forms passively when fresh magnesium from the base magnesium substrate 36, 38 is exposed to atmospheric air or some other oxygen-containing medium. The surface coating 40 may also be a metallic conversion coating comprised of metal oxides, metal phosphates, or metal chromates. A typical thickness of the surface coating 40, if present, lies anywhere from 1 nm to 10 μm depending on the composition of the coating 40 and the manner in which the coating 40 is derived, although other thicknesses may be employed. Passively formed refractory oxide coatings, for example, often have thicknesses that range from 2 nm to 10 nm when the underlying magnesium material is a magnesium alloy. Taking into account the thicknesses of the base magnesium substrates 36, 38 and their surface coating(s) 40, if present, the overall thickness of each of the first and second magnesium workpieces 12, 14 preferably ranges of 0.4 mm to 6.0 mm, or more narrowly from 0.5 mm to 3.0 mm, at least at the weld site 16.

Referring back to FIG. 1, the remote laser welding apparatus 18 includes a scanning optic laser head 42. The scanning optic laser head 42 directs the laser beam 24 at the top surface 20 of the workpiece stack-up 10 which, here, is provided by the exterior outer surface 26 of the first metal workpiece 12. The directed laser beam 24 impinges the top surface 20 and, as shown in FIG. 4, has a beam spot 44, which is the sectional area of the laser beam 24 at a plane oriented along the top surface 20 of the stack-up 10. The scanning optic laser head 42 is preferably mounted to a robotic arm (not shown) that can quickly and accurately carry the laser head 42 to many different preselected weld sites 16 on the workpiece stack-up 10 in rapid programmed succession. The laser beam 24 used in conjunction with the scanning optic laser head 42 is preferably a solid-state laser beam operating with a wavelength in the near-infrared range (commonly considered to be 700 nm to 1400 nm) of the electromagnetic spectrum. Additionally, the laser beam 24 has a power level capability that can attain a power density sufficient to produce a keyhole, if desired, within the workpiece stack-up 10 during formation of the laser weld joint. The power density needed to produce a keyhole within the overlapping metal workpieces is typically in the range of 0.5-1.5 MW/cm².

Some examples of a suitable solid-state laser beam that may be used in conjunction with the remote laser welding apparatus 18 include a fiber laser beam, a disk laser beam, and a direct diode laser beam. A preferred fiber laser beam is a diode-pumped laser beam in which the laser gain medium is an optical fiber doped with a rare earth element (e.g., erbium, ytterbium, neodymium, dysprosium, praseodymium, thulium, etc.). A preferred disk laser beam is a diode-pumped laser beam in which the gain medium is a thin laser crystal disk doped with a rare earth element (e.g., a ytterbium-doped yttrium-aluminum garnet (Yb:YAG) crystal coated with a reflective surface) and mounted to a heat sink. And a preferred direct diode laser beam is a combined laser beam (e.g., wavelength combined) derived from multiple diodes in which the gain medium is multiple semiconductors such as those based on aluminum gallium arsenide (AlGaAS) or indium gallium arsenide (InGaAS). Laser generators that can generate each of those types of lasers as well as other variations are commercially available. Other solid-state laser beams not specifically mentioned here may of course be used.

The scanning optic laser head 42 includes an arrangement of mirrors 46 that can maneuver the laser beam 24 and thus convey the beam spot 44 along the top surface 20 of the workpiece stack-up 10 within an operating envelope 48 that encompasses the weld site 16. Here, as illustrated in FIG. 1, the portion of the top surface 20 spanned by the operating envelope 48 is labeled the x-y plane since the position of the laser beam 24 within the plane is identified by the “x” and “y” coordinates of a three-dimensional coordinate system. In addition to the arrangement of mirrors 46, the scanning optic laser head 42 also includes a z-axis focal lens 50, which can move a focal point 52 (FIG. 1A) of the laser beam 24 along a longitudinal axis 54 of the laser beam 24 to thus vary the location of the focal point 52 in a z-direction that is oriented perpendicular to the x-y plane in the three-dimensional coordinate system established in FIG. 1. Furthermore, to keep dirt and debris from adversely affecting the optical system components and the integrity of the laser beam 24, a cover slide 56 may be situated below the scanning optic laser head 42. The cover slide 56 protects the arrangement of mirrors 46 and the z-axis focal lens 50 from the surrounding environment yet allows the laser beam 24 to pass out of the scanning optic laser head 42 without substantial disruption.

The arrangement of mirrors 46 and the z-axis focal lens 50 cooperate during operation of the remote laser welding apparatus 18 to dictate the desired movement of the laser beam 24 and its beam spot 44 within the operating envelope 48 at the weld site 16 as well as the position of the focal point 52 along the longitudinal axis 54 of the beam 24. The arrangement of mirrors 46, more specifically, includes a pair of tiltable scanning mirrors 58. Each of the tiltable scanning mirrors 58 is mounted on a galvanometer 60. The two tiltable scanning mirrors 58 can move the location of the beam spot 44—and thus change the point at which the laser beam 24 impinges the top surface 20 of the workpiece stack-up 10—anywhere in the x-y plane of the operating envelope 48 through precise coordinated tilting movements executed by the galvanometers 60. At the same time, the z-axis focal lens 50 controls the location of the focal point 52 of the laser beam 24 in order to help administer the laser beam 24 at the correct power density and to attain the desired heat input both instantaneously and over time. All of these optical components 50, 58 can be rapidly indexed in a matter of milliseconds or less to advance the beam spot 44 of the laser beam 24 relative to the x-y plane of the top surface 20 of the workpiece stack-up 10 along a beam travel pattern of simple or complex geometry while controlling the location of the focal point 52.

A characteristic that differentiates remote laser welding from other conventional forms of laser welding is the focal length of the laser beam 24. Here, as shown in best in FIG. 1, the laser beam 24 has a focal length 62, which is measured as the distance between the focal point 52 and the last tiltable scanning mirror 58 that intercepts and reflects the laser beam 24 prior to the laser beam 24 impinging the top surface 20 of the workpiece stack-up 10 (also the exterior outer surface 26 of the first metal workpiece 12). The focal length 62 of the laser beam 24 is preferably in the range of 0.4 meters to 2.0 meters with a diameter of the focal point 52 typically ranging anywhere from 350 μm to 700 μm. The scanning optic laser head 42 shown generally in FIG. 1 and described above, as well as others that may be constructed somewhat differently, is commercially available from a variety of sources. Some notable suppliers of scanning optic laser heads and lasers for use with the remote laser welding apparatus 18 include HIGHYAG (Kleinmachnow, Germany) and TRUMPF Inc. (Farmington, Conn., USA).

In the presently disclosed laser welding method, and referring now to FIGS. 1-15, a laser weld joint 64 (FIGS. 1 and 10) is formed within the workpiece stack-up 10 and between the first and second metal workpieces 12, 14 (or the first, second, and third metal workpieces as illustrated in FIGS. 16-17 and described below) by momentarily melting the metal workpieces 12, 14 with the laser beam 24 and then allowing the melted workpieces portions to solidify. In particular, the laser beam 24 is maneuvered by the scanning optic laser head 42 to advance the laser beam 24 and its beam spot 44 relative to the top surface 20 of the workpiece stack-up 10 along a beam travel pattern 66 (FIGS. 10-15) while oscillating the position of the focal point 52 relative to the top surface 20 of the stack-up 10 along a dimension 68 oriented transverse to a top surface 20 (also referred to herein as “the transverse dimension 68”). The focal point oscillations are performed at least part of the time, and preferably for the entire time, while the beam spot 44 is being advanced along the beam travel pattern 66. The resultant laser weld joint 64 obtained by operation of the the laser beam 24 autogenously fusion welds the overlapping first and second metal workpieces 12, 14 together at the weld site 16.

The laser welding method is carried out by first providing the workpiece stack-up 10. This typically involves assembling or fitting the first and second metal workpieces 12, 14 together with overlapping flanges or other bonding regions. Once the workpiece stack-up 10 is provided, the laser beam 24 is directed at, and impinges, the top surface 20 of the stack-up 10 within the weld site 16, thus establishing the beam spot 44 where laser energy enters into and is initially absorbed by the stack-up 10. The heat generated from absorption of the focused energy of the laser beam 24 initiates melting of the first and second metal workpieces 12, 14 and creates a molten metal weld pool 70, as shown in FIGS. 2-3, which has a composition based on and derived from the compositions of the metal workpieces 12, 14. The molten metal weld pool 70 penetrates into the workpiece stack-up 10 from the top surface 20 towards the bottom surface 22. And, while the depth of penetration may vary to some extent, the molten metal weld pool 70 penetrates far enough into the workpiece stack-up 10 that it intersects the faying interface 34 established between the first and second metal workpieces 12, 14.

The laser beam 24, moreover, preferably has a power density sufficient to vaporize the workpiece stack-up 10 directly beneath the beam spot 44. This vaporizing action produces a keyhole 72, also depicted in FIGS. 2-3, which is a column of vaporized workpiece metal that oftentimes contains plasma. The keyhole 72 is formed within the molten metal weld pool 70 and exerts an outwardly-directed vapor pressure sufficient to prevent the surrounding molten metal weld pool 70 from collapsing inward. And, like the molten metal weld pool 70, the keyhole 72 also penetrates into the workpiece stack-up 10 from the top surface 20 towards the bottom surface 22 and intersects the faying interface 34 established between the first and second metal workpieces 12, 14. The keyhole 72 provides a conduit for the laser beam 24 to deliver energy down into the workpiece stack-up 10, thus facilitating relatively deep and narrow penetration of the molten metal weld pool 70 into the workpiece stack-up 10 and a relatively small surrounding heat-affected zone. The keyhole 72 and the surrounding molten metal weld pool 70 may fully or partially (as shown) penetrate the workpiece stack-up 10.

After the molten metal weld pool 70 and the optional keyhole 72 are created, and referring now to FIG. 10, the laser beam 24 is maneuvered such that its beam spot 44 is advanced relative to the x-y plane of the top surface 20 of the workpiece stack-up along the beam travel pattern 66. The beam travel pattern 66 includes one or more weld paths 74. Advancement of the beam spot 44 of the laser beam 24 along the beam travel pattern 66 is managed by precisely controlling the coordinated movements of the tiltable scanning mirrors 58 within the scanning optic laser head 42. Such coordinated movements of the scanning mirrors 58 can rapidly move the beam spot 44 to trace a wide variety of beam travel patterns of simple or complex shape as projected onto the top surface 20 of the workpiece stack-up 10. Once the beam spot 44 of the laser beam 24 has finished tracing the beam travel pattern 66, the transmission of the laser beam 24 is ceased and, accordingly, the laser beam 24 is no longer directed at the top surface 20 of the workpiece stack-up 10. Here, in FIG. 10, a representative beam travel pattern 66 is depicted that shows a single weld path 74 extending between a first point 76 and a second point 78 that may or may not correspond to the points of initial and final laser beam impingement with the top surface 20 of the stack-up 10.

The position of the focal point 52 of the laser beam 24 is oscillated with respect to the top surface 20 of the stack-up 10 along the transverse dimension 68 at least part of the time during advancement of the beam spot 44 of the laser beam 24 along the beam travel pattern 66. The focal point oscillations are performed as the beam spot 44 is advanced between the spaced apart first and second points 76, 78 of the weld path(s) 74. As such, in one embodiment, the position of the focal point 52 is oscillated along each of the one or more weld paths 74 over the course of the entire beam travel pattern 66. In an alternative embodiment, however, the position of the focal point 52 is oscillated as the beam spot 44 is advanced over a certain designated part or parts of the beam travel pattern 66, while being held constant as the beam spot 44 is advanced along the other part or parts of the beam travel pattern 66. If the position of the focal point 52 is varied only some of the time, as is the case in the latter embodiment mentioned above, the oscillations may occur over at least 40% of the beam travel pattern 66 or, more preferably, at least 70% of the beam travel pattern 66.

The act of oscillating the position of the focal point 52 of the laser beam 24 results in a focal distance 80 of the laser beam 24—which is the distance between the focal point 52 and the top surface of the workpiece stack-up 10 as measured on the longitudinal axis 54 of the beam 24—being cyclically varied along the transverse dimension 68 over time. In other words, the focal point 52 of the laser beam experiences repeating back-and-forth movement in the transverse dimension 68, which is a dimension that represents overall displacement parallel to the longitudinal axis 54 of the laser beam 24, so as to repetitively change the focal distance 80 of the laser beam 24 as the beam spot 44 is being advanced along the weld path(s) 74 of the beam travel pattern 66 between the spaced apart first and second points 76, 78. In particular, and as shown best in FIGS. 2-3 and 9, the focal point oscillation comprises a series of focal point component runs 82 in which the focal point 52 moves from a maximum focal position 84 to a minimum focal position 86, or vice versa, and in so doing covers a distance (in each run) along the transverse dimension 68 that ranges between 10 mm and 300 mm or, more narrowly, between 20 mm and 100 mm. The maximum focal position 84 is the position reached by the focal point 52 on the longitudinal beam axis 54 that is closest to the scanning optic welding head 42 and the minimum focal position is position reached by the focal point 52 that is farthest from the scanning optic welding head 42.

Because the position of the focal point 52 is oscillated relative to the top surface 20 of the workpiece stack-up 10, the scale upon which the focal distance 80 is measured for purposes of this description uses the top surface 20 of the stack-up 10 as the position of zero reference. In that regard, the focal distance 80 has a positive value when the focal point 52 of the laser beam 24 is positioned above the top surface 20 of the workpiece stack-up 10, and movement of the focal point 52 towards the maximum focal position 84 is considered to be movement in the positive direction 68′ of the transverse dimension 68. Likewise, the focal distance 80 has a negative value when the focal point 52 of the laser beam is positioned below the top surface 20, and movement of the focal point 52 towards the minimum focal position 86 is considered to be movement in the negative direction 68″ of the transverse dimension 68. The position of the focal point 52 may be oscillated in an assortment of ways to affect the focal distance 82. For example, the maximum focal position 84 may be located above the top surface 20 of the workpiece stack-up 10 and the minimum focal position 84 may be located below the top surface 20, as shown in FIGS. 2-3, meaning that the focal distance 80 changes from positive to negative, or from negative to positive, with each focal point component run 82. Alternatively, both the maximum and minimum focal positions 84, 86 may be located above the top surface 20 or below the top surface 20, meaning that the focal distance 80 remains positive or negative, respectively, over the course of each focal point component run 82.

The locations of the maximum and minimum focal positions 84, 86 may vary depending on the composition and thicknesses of the workpieces 12, 14 as well as the desired heat input associated with the molten metal weld pool 70 and the optional keyhole 72. The maximum focal position 84 may, for instance, be located anywhere between +100 mm (i.e., 100 mm above the top surface 20) and −90 mm (i.e., 100 mm above the top surface 20), or more narrowly between +50 mm and −30 mm, and the minimum focal position 86 may be located anywhere between +90 mm and −100 mm, or more narrowly between +30 mm and −50 mm. The maximum and minimum focal positions 84, 86 may be constant across the many focal point component runs 82 (as depicted in FIG. 9) and, additionally, the targeted cyclical variations of the focal distance 80 may be periodic or nonperiodic as a function of time. In alternative embodiments, however, the maximum and minimum focal positions 84, 86 may be different across the many focal point component runs 80 such as, for example, with damping or growing focal point oscillations. The frequency at which the focal point 52 is oscillated may, in many instances, fall within the range of 10 Hz and 6000 Hz or, more narrowly, within the range of 20 Hz and 2000 Hz, regardless of how the oscillation is carried out (e.g., periodic, nonperiodic, damping, growing, etc.). The focal point oscillation frequency is a measure of how many focal point component runs 82 are completed on a per second basis.

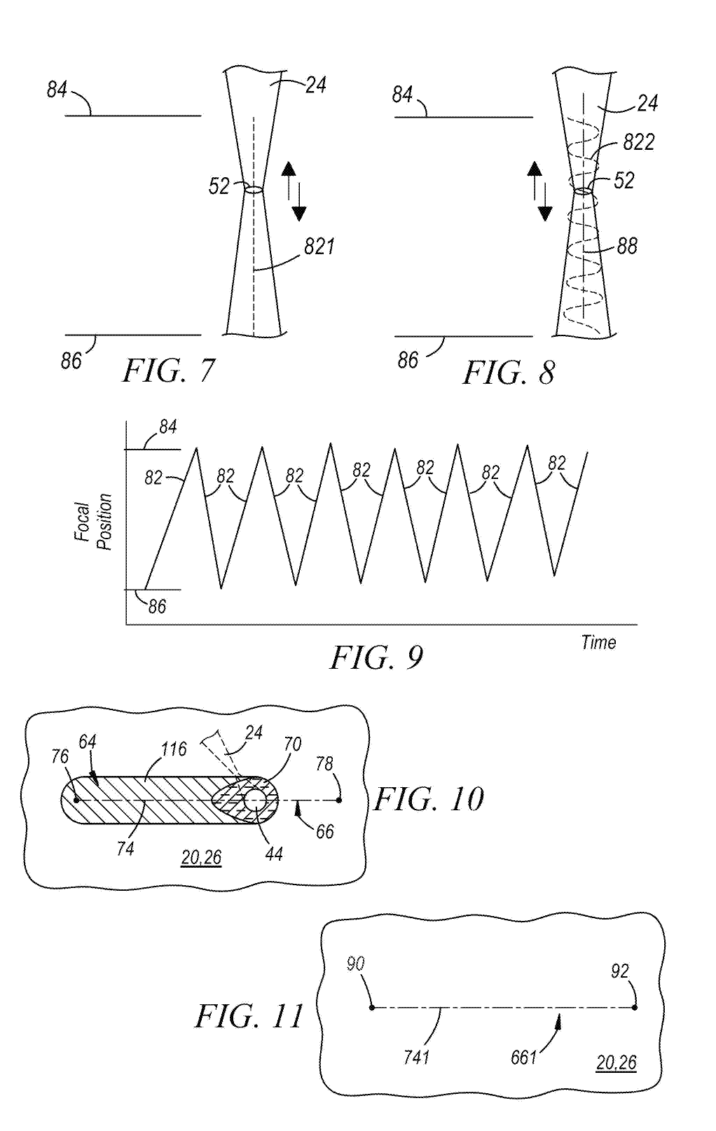

The position of the focal point 52 may be oscillated in linear or undulating fashion. The focal point oscillation is linear when, during each of the focal point component runs 82, the focal point 52 is moved between its maximum and minimum focal positions 84, 86 in a linear trajectory 821 along the transverse dimension 68 as shown in FIG. 7. In contrast, as shown in FIG. 8, the focal point oscillation is undulating when, during each of the focal point component runs 82, the focal point 52 is moved between its maximum and minimum focal positions 84, 86 in an undulating trajectory 822 along the transverse dimension 68, which incorporates continuous forward progression of the focal point 86 along towards the maximum or minimum focal position 84, 86 in a mean forward direction 88 while experiencing repeated back-and-forth fluctuations of the focal point 52 that deviate laterally from the mean forward direction 88. These fluctuations may have peak-to-peak amplitudes in the range of 0.2 mm to 2.0 mm and wavelengths in the range of 50 μm to 2000 μm. The position of the focal point 52 may of course be oscillated in other fashions besides linear and undulating including, for example, a combination of linear and undulating in which some of the focal point component runs 82 follow a linear trajectory and other of the focal point component runs follow an undulating trajectory.

The positional oscillation of the focal point 52 is preferably carried out between the spaced apart first and second points 76, 78 of the weld path(s) 74 of the beam travel pattern 66 while keeping the power level and the travel speed of the laser beam constant. Maintaining a constant power level and travel speed helps create and sustain a coherent molten metal weld pool 70 and a stable keyhole 72, if present, and also helps manage the heat input to the workpiece stack-up 10 during the time position of the focal point 52 is being oscillated. In general, the heat input of the laser beam 24 increases with an increasing power level and/or a decreasing travel speed and, likewise, the heat input decreases with a decreasing power level and/or an increasing travel speed. Here, at least while the position of the focal point 52 is being oscillated, the power level of the laser beam 24 is preferably maintained at a constant level in the range of 0.5 kilowatts (kW) to 10 kW or, more narrowly, in the range of 1 kW and 6 kW, and the travel speed of the laser beam 24 (and thus the beam spot) along the weld path(s) 74 is preferably maintained at a constant speed in the range of 0.8 meters/min (m/min) and 100 m/min or, more narrowly, in the range of 1 m/min and 50 m/min.

A particularly preferred manner of oscillating the position of the focal point 52 during advancement of the laser beam 24 along the weld path(s) 74 of the beam travel pattern 66 in accordance with the disclosed laser welding method is depicted graphically in FIG. 9. There, as shown, the position of the focal point 52 is oscillated periodically as a function of time with each of the maximum focal position 84 and the minimum focal position 86 of the many focal point component runs 82 remaining constant. Additionally, the transitions between each pair of consecutive focal point component runs 82 is abrupt, meaning that the focal point 52 is not held for an extended period of time at either of the maximum or minimum focal positions 84, 86 such that the end of one focal point component run 82 is essentially the start of the next focal point component run 82. Each of the focal point component runs 82 that is graphically represented here in FIG. 9, moreover, is effectuated by movement of the focal point 52 in either a linear or undulating trajectory, as described above, and the oscillation of the focal point 52 as shown is carried out while maintaining the laser beam 24 at a constant power level and travel speed.

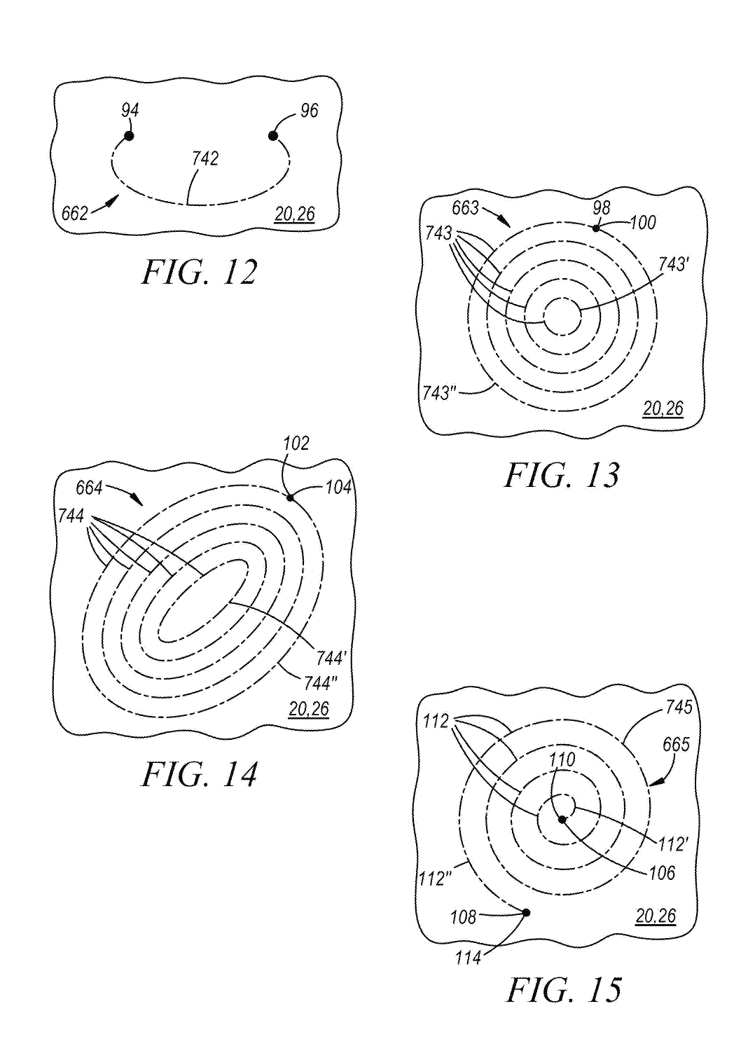

The beam travel pattern 66 traced by the laser beam 24 may be any of a wide variety of geometric patterns. Several exemplary beam travel patterns 66 are shown here in FIGS. 11-15 from the perspective of a two-dimensional plan view of the top surface 20 of the workpiece stack-up 10. For instance, the beam travel pattern 66 may be a linear stitch pattern 661 (FIG. 11), a curved or “C-shaped” staple pattern 662 (FIG. 12), a circle pattern 663 (FIG. 13), an elliptical pattern 664 (FIG. 14), or a spiral pattern 665 (FIG. 15), to name but a few examples. In the linear stitch pattern 661 of FIG. 11, the beam spot 44 of the laser beam 24 is advanced along a single linear weld path 741 from a start point 90 to an end point 92. The start point 90 and the end point 92 may correspond with the first point 76 and the second point 78, respectively, between which the position of the focal point 52 is oscillated, although the correlation of those two sets of points is not necessarily required. Likewise, in the staple pattern 662 of FIG. 12, the beam spot 44 of the laser beam 24 is advanced along a curved and circumferentially open weld path 742 from a start point 94 to an end point 96. The curved and circumferentially open weld path 742 may be semi-circular or semi-eliptical path in shape. And, like before, the start point 94 and the end point 96 may or may not correspond to the first point 76 and the second point 78, respectively, between which the position of the focal point 52 is oscillated.

In the circle pattern 663 of FIG. 13, the beam spot 44 of laser beam 24 is advanced along one or more circular weld paths 743 from a start point 98 to an end point 100 (shown only on one of the illustrated circular weld paths 743). The start point 98 and the end point 100 of the circular weld path(s) 743 may be the same or, alternatively, they may be different such as when the beam spot 44 is advanced past the start point 98 on the same weld path 743. Moreover, if the circle pattern 663 includes a series of radially-spaced and unconnected circular weld paths 743 concentrically arranged around a common midpoint, as shown in FIG. 13, the number of circular weld paths 743 may range from two to twenty. In that regard, the series of circular weld paths 743 includes an innermost circular weld path 743′ and an outermost circular weld path 74″, and all of the weld paths 743 in between may be evenly spaced apart or they may be spaced apart at varying distances. Regardless of the uniformity in spacing or lack thereof, the distance between radially-aligned points on each pair of adjacent circular weld paths 743 (or step size) preferably lies between 0.01 mm and 0.8 mm. Moreover, as before, the start point 98 and the end point 100 of each of the circular weld paths 743 may or may not correspond to the spaced apart first and second points 76, 78 between which the position of the focal point 52 is oscillated.

The elliptical pattern 664 shown in FIG. 14 is similar in all material respects to the circular pattern 663 shown in FIG. 13 except for the fact that the beam spot 44 of the laser beam 24 is advanced along one or more elliptical weld paths 744 from a start point 102 to an end point 104 in lieu of the one or more circular weld paths 743. As such, if the elliptical pattern 644 includes a series of radially-spaced and unconnected elliptical weld paths 744 concentrically arranged around a common midpoint, as shown, the number of elliptical weld paths 744 may range from two to twenty. The elliptical weld paths 744 may also be spaced apart between an innermost elliptical weld path 744′ and an outermost circular weld path 744″ in the same manner as the circular weld paths 743 of FIG. 13; that is, a distance between radially-aligned points on each pair of adjacent elliptical weld paths 744 (or step size) preferably lies between 0.01 mm and 0.8 mm. Furthermore, as before, the start point 102 and the end point 104 of each of the elliptical weld paths 744 may or may not correspond to the spaced apart first and second points 76, 78 between which the position of the focal point 52 is oscillated.

In the spiral pattern 665 of FIG. 15, the beam spot 44 of the laser beam 24 is advanced from a start point 106 to an end point 108 along a single spiral weld path 745 that revolves around an innermost point 110 to produce a plurality of turnings 112 that expand radially outwardly between the innermost point 110 and an outermost point 114. Anywhere from two to twenty turnings 112 may be present. The start point 106 of the spiral weld path 745 may be the innermost point 110 of an innermost turning 112′ of the weld path 745, and the end point 108 may be the outermost point 110 of an outermost turning 112″ of the weld path 745, or vice versa. The spiral weld path 745 may be continuously curved, as shown here in FIG. 15, and may further be arranged into an Archimedean spiral in which the turnings 112 of the weld path 745 are spaced equidistantly from each other by a step distance that preferably ranges from 0.01 mm 0.8 mm as measured between radially-aligned points on each pair of adjacent turnings 112. Additionally, as before, the start point 106 and the end point 108 of the spiral weld path 745 may correspond with the first point 76 and the second point 78, respectively, between which the position of the focal point 52 is oscillated, although the correlation of those two sets of points is not necessarily required.

Referring back to FIGS. 2-3 and 10, as the beam spot 44 of the laser beam 44 is being advanced along the beam travel pattern 66, the keyhole 72 (if present) and the molten metal weld pool 70 that surrounds the optional keyhole 72 are translated along a corresponding route within the stack-up 10 and relative to the top surface 20 since they track the movement of the beam spot 44. Such advancement of the beam spot 44 causes the penetrating molten metal weld pool 70 to flow around and behind the beam spot 44 within the workpiece stack-up 10, resulting in the molten metal weld pool 70 elongating in the wake of the advancing progression of the beam spot 44. Upon continued advancement and/or halting transmission of the laser beam 24, the molten workpiece material produced by the laser beam 24 and the advancement of the beam spot 44 cools and solidifies into resolidified composite workpiece material 116. Indeed, and depending on exactly how the laser beam 24 is maneuvered, the molten metal weld pool 70 may solidify into a defined trail of resolidified composite workpiece material 116, or it may merge and grow into a larger melt puddle that solidifies into a consolidated nugget of resolidified composite workpiece material 116. Regardless of its final shape and structure, the collective resolidified composite metal workpiece material 116 constitutes the laser weld joint 64 that autogenously fusion welds the metal workpieces 12, 14 together at the weld site 16.

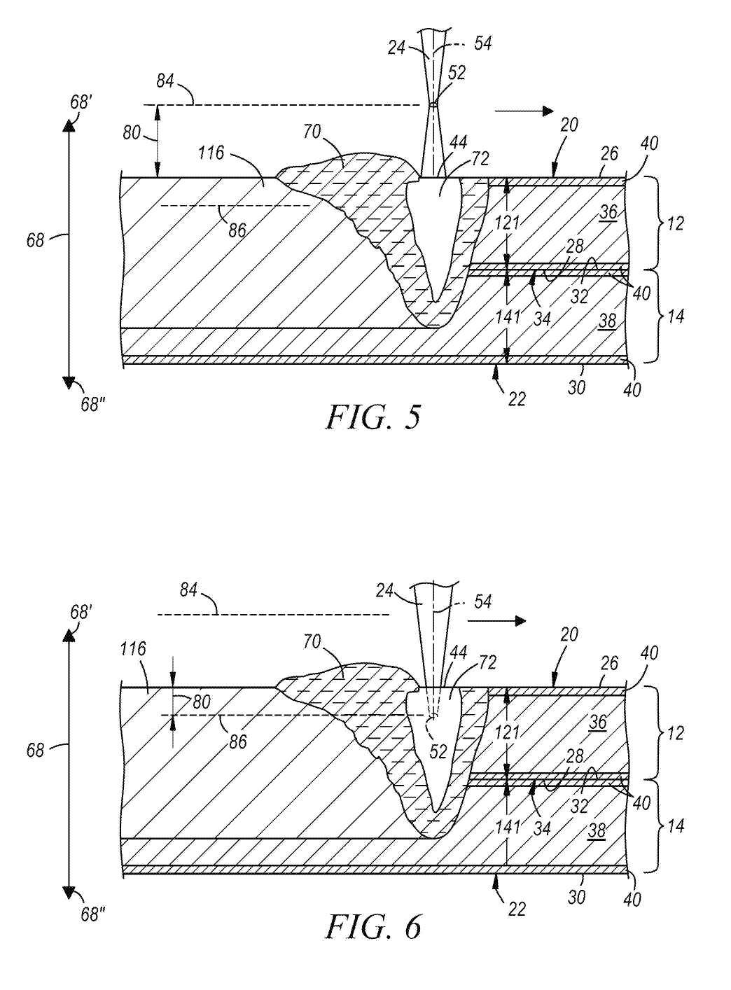

The depth of penetration of the keyhole 72 and the surrounding molten metal weld pool 70 is controlled during advancement of the beam spot 44 of the laser beam 24 along the beam travel pattern 66 to ensure the metal workpieces 12, 14 are fusion welded together by the laser weld joint 64. In particular, as mentioned above, the keyhole 72 and the molten metal weld pool 70 penetrate into the workpiece stack-up 10 and intersect the faying interface 34 established between the first and second metal workpieces 12, 14. The keyhole 72 and the molten metal weld pool 70 may fully or partially penetrate the workpiece stack-up 10. For instance, in one embodiment, as illustrated in FIGS. 2-3, the keyhole 72 and the molten metal weld pool 70 fully penetrate the workpiece stack-up 10 when the first and second metal workpieces 12, 14 are steel workpieces, but only partially penetrate the workpiece stack-up 10 when the first and second metal workpieces 12, 14 are aluminum workpieces or magnesium workpieces. A fully penetrating keyhole 72 and molten metal weld pool 70 extend entirely through the first and second metal workpieces from the top surface 20 to the bottom surface 22 of the workpiece stack-up 10. A partially penetrating keyhole 72 and molten metal weld pool 70, on the other hand, extend entirely through the first metal workpiece 12 but only partially through the second metal workpiece 14, as illustrated in FIGS. 5-6.

FIGS. 1-15 illustrate the above-described embodiments of the disclosed laser welding method in the context of the workpiece stack-up 10 being a “2T” stack-up that includes only the first and second metal workpieces 12, 14 with their single faying interface 34. The same laser welding method, however, may also be carried out when the workpiece stack-up, identified by reference numeral 10′, is a “3T” stack-up that includes an additional third metal workpiece 150, with a thickness 151, that overlaps and is situated between the first and second metal workpieces 12, 14, as depicted in FIGS. 16-17. In fact, regardless of whether the workpiece stack-up 10 is a 2T or a 3T stack-up, the laser welding method does not have to be modified all that much to form the laser weld joint 64. And, in each instance, the laser weld joint 64 can achieve good quality strength properties by oscillating the position of the focal point 52 between the first and second spaced apart points 74, 76 as the beam spot 44 is advanced relative to the top surface 20 of the workpiece stack-up 10 along the beam travel pattern 66, despite the fact that at least one, and maybe all, of the metal workpieces 12, 150, 14 includes a surface coating 40.

The additional third metal workpiece 150 includes a third base metal substrate 152 that may be optionally coated with the same surface coating 40 described above. When the workpiece stack-up 10′ includes the first, second, and third overlapping metal workpieces 12, 150, 14, the base metal substrate 36, 152, 38 of at least one of the workpieces 12, 150, 14, and sometimes all of them, may include the surface coating 40; that is, one of the following scenarios applies: (1) only the first metal workpiece 12 includes a surface coating 40; (2) only the third metal workpiece 150 includes a surface coating 40; (3) only the second metal workpiece 14 includes a surface coating 40; (4) each of the first and third metal workpieces 12, 150 includes a surface coating 40; (5) each of the first and second metal workpieces 12, 14 includes a surface coating 40; or (6) each of the third and second metal workpieces 150, 14 includes a surface coating 40. As for the characteristics of the third base metal substrate 152, the descriptions above regarding the first and second base metal substrates 36, 38 of the same base metal group (i.e., steel, aluminum, or magnesium) are equally applicable to that substrate 152 as well. And while the same general descriptions apply to the several metal workpieces 12, 150, 14, there is no requirement that the metal workpieces 12, 150, 14 be identical to one another. In many instances, the first, second, and third metal workpieces 12, 150, 14 are different in some aspect from each other whether it be composition, thickness, and/or form.

As a result of stacking the first, second, and third metal workpieces 12, 150, 14 in overlapping fashion to provide the workpiece stack-up 10′, the third metal workpiece 150 has two faying surfaces: a third faying surface 154 and a fourth faying surface 156. The third faying surface 154 overlaps and confronts the first faying surface 28 of the first metal workpiece 12 and the fourth faying surface 156 overlaps and confronts the second faying surface 32 of the second metal workpiece 14. The confronting first and third faying surfaces 28, 154 of the first and third metal workpieces 12, 150 establish a first faying interface 158 and the confronting second and fourth faying surfaces 32, 156 of the second and third metal workpieces 150, 14 establish a second faying interface 160, both of which extend through the weld site 16. These faying interfaces 158, 160 are the same type and encompass the same attributes as the faying interface 34 already described above with respect to FIGS. 1-15. Consequently, in this embodiment as described herein, the exterior outer surfaces 26, 30 of the flanking first and second metal workpieces 12, 14 still face away from each other in opposite directions and continue to provide the top and bottom surfaces 20, 22 of the workpiece stack-up 10′, respectively.

The laser weld joint 64 is formed in the “3T” workpiece stack-up 10′ by the laser beam 24 in the same manner as previously described. In particular, the laser beam 24 is directed at, and impinges, the top surface 20 of the workpiece stack-up 10 (also the exterior outer surface 26 of the first metal workpiece 12) to create the molten metal weld pool 70 and, optionally, the keyhole 72 within the weld pool 70 beneath the beam spot 44 of the laser beam 24. The keyhole 72 and the molten metal weld pool 70 penetrate into the workpiece stack-up 10 from the top surface 20 towards the bottom surface 22, either fully or partially, and intersect each of the faying interfaces 158, 160 established within the stack-up 10. The beam spot 44 is then advanced relative to the top surface 20 of the workpiece stack-up 10′ along the beam travel pattern 66. Any of the exemplary beam travel patterns 66 depicted in FIGS. 11-15, as well as others not depicted, may be traced by the beam spot 44. Moreover, the position of the focal point 52 is oscillated between the first and second spaced apart points 76, 78 of the weld path(s) 74 of the beam travel pattern 66, as described above, as the beam spot 44 of the laser beam 24 is advanced along the beam travel pattern 66. The resultant weld joint 64 formed by the laser beam 24 includes resolidified composite workpiece material 116 and fusion welds the first, second, and third metal workpieces 12, 150, 14 together at the weld site 16.

The above description of preferred exemplary embodiments and specific examples are merely descriptive in nature; they are not intended to limit the scope of the claims that follow. Each of the terms used in the appended claims should be given its ordinary and customary meaning unless specifically and unambiguously stated otherwise in the specification.

1. A method of laser welding a workpiece stack-up that includes at least two overlapping metal workpieces, the method comprising:
providing a workpiece stack-up that includes overlapping metal workpieces, the workpiece stack-up comprising at least a first metal workpiece and a second metal workpiece, the first metal workpiece providing a top surface of the workpiece stack-up and the second metal workpiece providing a bottom surface of the workpiece stack-up, wherein a faying interface is established between each pair of adjacent overlapping metal workpieces within the workpiece stack-up, and wherein all of the overlapping metal workpieces of the workpiece stack-up are steel workpieces, aluminum workpieces, or magnesium workpieces;
directing a laser beam at the top surface of the workpiece stack-up, the laser beam impinging the top surface and creating a molten metal weld pool that penetrates into the workpiece stack-up from the top surface towards the bottom surface and that intersects each faying interface established within the workpiece stack-up, the laser beam having a beam spot oriented along the top surface of the workpiece stack-up; and
forming a laser weld joint that fusion welds the overlapping metal workpieces together by advancing the beam spot relative to a plane of the top surface of the workpiece stack-up and along a beam travel pattern and, additionally, oscillating a position of a focal point of the laser beam along a dimension oriented transverse to the top surface at least part of the time while advancing the laser beam relative to a plane of the top surface along a beam travel pattern and maintaining a constant power level and travel speed of the laser beam.

2. The method set forth in claim 1, wherein the first metal workpiece has an exterior outer surface and a first faying surface, and the second metal workpiece has an exterior outer surface and a second faying surface, the exterior outer surface of the first metal workpiece providing the top surface of the workpiece stack-up and the exterior outer surface of the second metal workpiece providing the bottom surface of the workpiece stack-up, and wherein the first and second faying surfaces of the first and second metal workpieces overlap and confront to establish a first faying interface.

3. The method set forth in claim 1, wherein the first metal workpiece has an exterior outer surface and a first faying surface, and the second metal workpiece has an exterior outer surface and a second faying surface, the exterior outer surface of the first metal workpiece providing the top surface of the workpiece stack-up and the exterior outer surface of the second metal workpiece providing the bottom surface of the workpiece stack-up, and wherein the workpiece stack-up comprises a third metal workpiece situated between the first and second metal workpieces, the third metal workpiece having opposed third and fourth faying surfaces, wherein the third faying surface overlaps and confronts the first faying surface of the first metal workpiece to establish a first faying interface and the fourth faying surface overlaps and confronts the second faying surface of the second metal workpiece to establish a second faying interface.

4. The method set forth in claim 1, wherein oscillating the position of the focal point comprises alternately moving the focal point of the laser beam along a series of focal point component runs so as to cyclically vary a focal distance of the laser beam over time along the dimension oriented transverse to the top surface as the beam spot is being advanced along the beam travel pattern, wherein each of the focal point component runs has a maximum focal position and a minimum focal position between which the focal point is moved, and wherein the focal point is alternately moved along the series of focal point component runs at a frequency in the range of 10 Hz to 6000 Hz.

5. The method set forth in claim 4, wherein, over the course of the series of focal point component runs, the maximum focal positions and the minimum focal positions remain constant.

6. The method set forth in claim 5, wherein the position of the focal point is oscillated such that the focal distance of the laser beam is cyclically varied periodically as a function of time.

7. The method set forth in claim 4, wherein, for each focal point component run, the focal point follows a linear trajectory along the dimension oriented transverse to the top surface when moving from the maximum focal position to the minimum focal position of from the minimum focal position to the maximum focal position.

8. The method set forth in claim 4, wherein, for each focal point component run, the focal point follows an undulating trajectory along the dimension oriented transverse to the top surface when moving from the maximum focal position to the minimum focal position of from the minimum focal position to the maximum focal position.

9. The method set forth in claim 4, wherein, relative to the top surface of the workpiece stack-up, the maximum focal position of each of the component runs is between +100 mm and −90 mm and the minimum focal position of each of the component runs is between +90 mm and −100 mm.

10. The method set forth in claim 1, wherein a keyhole is produced underneath the beam spot and within the molten metal weld pool.

11. The method set forth in claim 1, wherein the overlapping metal workpieces of the workpiece stack-up are steel workpieces, and wherein at least one of the steel workpieces includes a surface coating comprised of a zinc-based material or an aluminum-based material.

12. The method set forth in claim 11, wherein at least one of the steel workpieces includes a surface coating comprised of zinc.

13. The method set forth in claim 1, wherein the overlapping metal workpieces of the workpiece stack-up are aluminum workpieces, and wherein at least one of the aluminum workpieces includes a native refractory oxide surface coating.

14. The method set forth in claim 1, wherein the overlapping metal workpieces of the workpiece stack-up are magnesium workpieces, and wherein at least one of the magnesium workpieces includes a native refractory oxide surface coating.

15. The method set forth in claim 1, wherein advancing the beam spot of the laser beam along the beam travel pattern and additionally oscillating the position of the focal point of the laser beam are performed by a scanning optic laser head having tiltable scanning mirrors whose movements are coordinated to maneuver the laser beam and thus advance the beam spot relative to the top surface of the workpiece stack-up and along the beam travel pattern.

16. A method of laser welding a workpiece stack-up that includes at least two overlapping metal workpieces, the method comprising:
providing a workpiece stack-up that includes two or three overlapping metal workpieces, the workpiece stack-up comprising at least a first metal workpiece and a second metal workpiece, the first metal workpiece providing a top surface of the workpiece stack-up and the second metal workpiece providing a bottom surface of the workpiece stack-up, wherein a faying interface is established between each pair of adjacent overlapping metal workpieces within the workpiece stack-up, and wherein all of the overlapping metal workpieces of the workpiece stack-up are steel workpieces, aluminum workpieces, or magnesium workpieces;
operating a scanning optic laser head to direct a solid-state laser beam at the top surface of the workpiece stack-up, the laser beam having a beam spot at the top surface of the workpiece stack-up and creating a molten metal weld pool and a keyhole surrounded by the molten metal weld pool, each of the molten metal weld pool and the keyhole penetrating into the workpiece stack-up from the top surface towards the bottom surface; and
advancing the beam spot of the laser beam relative to the top surface of the workpiece stack-up and along a beam travel pattern through coordinated movement of tiltable scanning mirrors contained within the scanning optic laser head, such advancement of the beam spot of the laser beam translating the keyhole and the surrounding molten metal weld pool along a corresponding route to form a laser weld joint comprised of resolidified composite metal workpiece material derived from each of the metal workpieces penetrated by the molten metal weld pool; and
oscillating a focal point of the laser beam along a dimension oriented transverse to the top surface at least part of the time while advancing the beam spot of the laser beam relative to a plane of the top surface along a beam travel pattern, wherein oscillating the focal point comprises alternately moving the focal point along a series of focal point component runs, each of which has a maximum focal position and a minimum focal position, so as to cyclically vary a focal distance of the laser beam over time, the maximum focal positions and the minimum focal positions of the series of focal point component runs remaining constant and the focal distance being cyclically varied periodically as a function of time, and, wherein, for each focal point component run, the focal point follows either a linear trajectory or an undulating trajectory when moving from the maximum focal position to the minimum focal position of from the minimum focal position to the maximum focal position.

17. The method set forth in claim 16, wherein the position of the focal point is oscillated over the entirety of the beam travel pattern.

18. The method set forth in claim 16, wherein the beam travel pattern along which the beam spot of the laser beam is advanced within the plane of the top surface of the workpiece stack-up comprises:
(a) a linear weld path extending from a start point to an end point;
(b) a curved and circumferentially open weld path extending from a start point to an end point;
(c) one or more circular weld paths extending from a start point to an end point;
(d) one or more elliptical weld paths extending from a start point to an end point; or
(e) a spiral weld path that revolves around an innermost point to produce a plurality of turnings that expand radially outwardly from the innermost point on an innermost turning to an outermost point on an outermost turning.

19. A method of laser welding a workpiece stack-up that includes at least two overlapping metal workpieces, the method comprising:
providing a workpiece stack-up that includes overlapping metal workpieces, the workpiece stack-up comprising at least a first metal workpiece and a second metal workpiece, the first metal workpiece providing a top surface of the workpiece stack-up and the second metal workpiece providing a bottom surface of the workpiece stack-up, wherein a faying interface is established between each pair of adjacent overlapping metal workpieces within the workpiece stack-up, and wherein all of the overlapping metal workpieces of the workpiece stack-up are steel workpieces, aluminum workpieces, or magnesium workpieces;
advancing a beam spot of a laser beam relative to the top surface of the workpiece stack-up and along a beam travel pattern using a remote laser welding apparatus, such advancement of the beam spot of the laser beam translating a molten metal weld pool, which penetrates into the workpiece stack-up and intersects each faying interface established within the stack-up, along a corresponding route to form resolidified composite metal workpiece material derived from each of the metal workpieces penetrated by the molten metal weld pool; and
oscillating a focal point of the laser beam along a dimension oriented transverse to the top surface of the workpiece stack-up while advancing the beam spot of the laser beam relative to a plane of the top surface between spaced apart first and second points of a weld path of the beam travel pattern, wherein oscillating the focal point comprises alternately moving the focal point along a series of focal point component runs, each of which has a maximum focal position and a minimum focal position, so as to cyclically vary a focal distance of the laser beam over time, and, wherein, for each focal point component run, the focal point follows either a linear trajectory or an undulating trajectory when moving from the maximum focal position to the minimum focal position of from the minimum focal position to the maximum focal position.

20. The method set forth in claim 19, wherein a constant power level and a constant travel speed of the laser beam are maintained while the position of the focal point is oscillated as the beam spot of the laser beam is advanced along the weld path between the spaced apart first and second points, and wherein the constant power level is in the range of 0.5 kW and 10 kW and the constant travel speed is in the range of 0.8 m/min and 100 m/min.
